(19) United States
(12) Patent Application Publication
(10) Pub. No.: US 2026/0313049 A1
(43) Pub. Date: Oct. 8, 2026

(54) Controlling the Communication of a Driver of a Motor Vehicle

(71) Applicant: Bayerische Motoren Werke Aktiengesellschaft, Muenchen (DE)

(72) Inventors: Albrecht NEFF, Sunnyvale, CA (US); Shitij RASTOGI, Mountain View, CA (US)

(21) Appl. No.: 18/998,607

(22) PCT Filed: Sep. 19, 2023
(86) PCT No.: PCT/EP2023/075827

§ 371 Date: Jan. 27, 2025

(30) Foreign Application Priority Data
Sep. 22, 2022 (DE) 10 2022 124 353.2

(51) Int. Cl. H04M 1/72409; H04M 1/72439

(52) U.S. Cl. CPC H04M 1/724098; H04M 1/72439

(57) ABSTRACT

The present disclosure relates to a method for controlling the communication of a driver of a motor vehicle with another person outside of the motor vehicle, comprising the steps: determining a driving situation of the motor vehicle; determining, based on the determined driving situation, a degree of attentiveness of the driver for driving the motor vehicle; determining that the communication jeopardizes the attentiveness being reached; and influencing the communication according to the attentiveness.

### BACKGROUND AND SUMMARY

The present disclosure relates to the communication of a driver of a motor vehicle with a person outside the vehicle. In particular, the present disclosure relates to ensuring driving safety of the motor vehicle during the communication.

A motor vehicle is driven by a driver. How much attention the driver has to devote to this activity is largely determined by the driving situation of the motor vehicle. For example, if the motor vehicle is in darkness and snowfall on a narrow mountain road, greater attention is generally required than when driving at moderate speed in daylight on a dry, well-maintained highway with little traffic.

While driving, the driver can communicate with a person outside the motor vehicle, for example on a telephone call or in a video conference. If the driving situation changes such that the driver has to concentrate more on driving the motor vehicle, the communication can have a disruptive effect on the driver. Even if, in such a situation, the driver themselves is participating less actively in the communication, they may continue to be exposed to the other person's flow of information.

It has been proposed to reduce certain information that affects the driver if the motor vehicle is in a demanding driving situation. For example, the volume of an entertainment system can be automatically reduced in the event of emergency braking. However, such systems usually only intervene in communication at a late stage. In addition, the driver is usually cut off from the communication, such that in the event of only moderate or briefly increased attention being required for a current driving situation, they may have difficulty continuing to follow the communication.

One of the objects underlying the present disclosure is to provide an improved technology for assisting a driver of a motor vehicle who communicates with a person outside the motor vehicle.

According to a first aspect of the present disclosure, a method for controlling a communication of a driver of a motor vehicle with another person outside the motor vehicle comprises steps for determining a driving situation of the motor vehicle; determining a level of attention of the driver required for driving the motor vehicle based on the determined driving situation; determining that the communication jeopardizes the required attention being achieved; and influencing the communication as a function of the required attention.

It has been recognized that influencing the communication gradually, in particular, allows the driver, on the one hand, to be sufficiently attentive to the task of driving or monitoring the motor vehicle, but on the other hand to be able to follow the communication better even if the traffic situation places changing demands on their attention. Preferably, a distraction, which is already caused by the intervention in the communication, can be avoided.

The attention required due to the driving situation can be determined based on various influences on the driver. As will be explained in more detail here, first factors may, for example, be external to the motor vehicle and, in particular, relate to visibility conditions, a routing, a traffic intensity or navigation. Second factors may relate to the motor vehicle itself and its operation or functioning, for example a required gear change, control of a drive motor, operation of an air conditioning system (HVAC) or putting on or switching off an external signaling or lighting apparatus. Third factors can be information or information streams to which the driver is exposed independently of the aforementioned communication, for example from children on board, a passenger or as a result of an output from an entertainment system.

In one or more embodiments, a distraction of the driver is determined that is independent of the driving situation and the communication. It can then be determined that the communication in combination with the distraction jeopardizes the required attention being achieved. The more the driver's attention is occupied by other events, circumstances or activities on board the motor vehicle, the less attention they can divide between driving the motor vehicle and communicating. The communication can be affected if the attention required for driving the motor vehicle and communicating exceeds a predetermined threshold value; wherein the threshold value can be lowered as a function of the specific distraction.

A type or degree of intervention in the communication can be selected or predetermined by the driver. Furthermore, the intervention can depend on the level of attention required, the present driving situation or a type of distraction. In one or more embodiments, the driver can make an association between a driving situation and an intervention in the communication.

The intervention in the communication can be gentle in order to avoid the driver being frightened or distracted by the loss of communication effort.

In one or more embodiments, a signal which, in particular, indicates a recommended reduction in the communication is provided to the driver. The signal can be provided if the required attention exceeds or threatens to exceed the threshold value. For example, a visual or audible signal can be used to prompt the driver to reduce or stop the communication. The other person can also receive the signal or be excluded therefrom.

In one or more embodiments, a message transported as part of the communication is delayed if the driver needs to achieve increased attention. The delay can relate to one or both communication directions. For example, a call or a video data stream can be interrupted for an extended period during a pause in the conversation or a flow of information from the communication can be temporarily stored and relayed at a slower pace. Once the required attention falls below the predetermined threshold value again, it is possible to catch up with the delayed communication, for example by relaying the flow of information from the buffer at a higher speed. Once the buffer is empty, the communication can be relayed at its original speed.

In one or more embodiments, a pre-announcement of an increased need for attention can be provided during a telephone call or a video conference. For example, a spoken message can be used to indicate an imminent driving situation, such as “merge soon”.

This message can be provided a predetermined time, for example approx. 5 to approx. 20 seconds, before the anticipated driving situation. The communication can be interrupted until the driving situation has been handled with the increased attention. In one or more embodiments, an indication of the anticipated start or the anticipated end of the driving situation can be provided, for example in the form of an announcement of the remaining time.

A message transported as part of the communication can be output to the driver with reduced urgency. For example, an audible message or information can be output more quietly or a visual message can be output in a smaller size, with reduced contrast or less brightly.

In one or more embodiments, a signal which, in particular, indicates a recommended reduction in the communication is provided to the other person. The signal can optionally also be provided to the driver. In general, when communicating with several people who are outside the motor vehicle, one or more of them may be affected by the intervention in the communication or the signal.

The signal is preferably configured to communicate to the other person that increased attention is required from the driver in order to drive the motor vehicle. The signal is also preferably selected such that it can be understood by the other person intuitively. For example, the signal can convey a circumstance which, according to usual experience, indicates a temporary interruption or reduction in the communication. In this way, the other person can receive an immediate impression that the driver is not able to follow the communication well. The other person can slow down the communication, make it less intensive or stop it until the situation on board the motor vehicle, which has been conveyed to them, is resolved.

The signal can be provided audibly in a first variant. For example, the signal can comprise a voice message that indicates a current driving situation requiring increased attention from the driver, such as a warning of a traffic jam or an imminent driving maneuver. The signal can also be an audible signal or a sound that is generally associated with a demanding driving situation, for example a signal sequence from a parking distance warning system, a siren or screeching tires.

Other sounds can be more subtle, such as the sound of a turn signal, a throat clearing or a spoken “psst”, “shh”, “wait” or “one moment please”. A synthetic signal is also conceivable. Influencing the communication in this way can be particularly effective if the other person is qualified to drive a motor vehicle or is driving another motor vehicle.

The warning or signal does not necessarily have to indicate a driving situation that corresponds to the present driving situation of the motor vehicle, but can also be output to represent a known driving situation with increased attention required from the driver. The audible output can be provided such that the driver cannot hear it or can only hear it at a lowered volume.

In a second variant, the communication comprises the provision or transmission of an image to the other person, wherein the signal can relate to a change in the image. The image can be generated on board the motor vehicle or information can be provided to create the image. In particular, the image can be provided as part of a video data stream, which can be created on board the motor vehicle or by a central location. For example, a video data stream from a camera aimed at the driver can be replaced by another video data stream, which can, for example, be captured from the environment of the motor vehicle, when a demanding driving situation is determined. Alternatively, the image can also be displayed in more blurred form or in a coarser resolution. In this way, the other person can recognize from the lack of visibility of the driver in the video data stream, on the one hand, and from a driving situation in the environment of the motor vehicle, on the other, that their communication with the driver is not the highest priority at the moment.

In one or more embodiments, the image of the driver can be replaced by a symbol that indicates the reduced availability of the driver in order to restrict the communication. For example, a traffic sign with suitable content can be shown, such as the German road traffic sign 101 (warning triangle with exclamation mark) for a general warning or a similar sign for a more specific warning, for example from the range 101-10 to 105-20. The sign shown can be adapted to a traffic system that applies in the area of the motor vehicle or in the area of the other person.

A type of influence is determined as a function of the communication. For example, the communication can be influenced as a function of the other person, the communication channel used or the communication content.

An imminent driving situation is predicted and the level of attention required for the imminent driving situation is determined. The communication is further preferably influenced a predetermined time before the required level of attention is likely to exceed the predetermined threshold value.

The influence can be terminated after the particular driving situation has ended. The influence is controlled in a smooth transition so that it does not start or end abruptly.

The transition is preferably determined based on the prediction, but can also take place in a firmly predetermined manner.

Adapting the communication at an early stage can avoid the driver becoming distracted or irritated by the intervention in the communication at the very moment when they should be devoting more attention to driving the motor vehicle.

It is further preferably predicted for how long the required attention is above a predetermined threshold value. The communication can then be influenced as a function of the determined duration. In particular, the type of influence can be selected as a function of the expected duration. For example, just a short duration could be spanned by pausing a transmitted information stream; for a duration that is expected to be longer, on the other hand, a signal could be output to the external person.

A similar approach is also possible without prediction. The communication can be influenced as a function of a duration for which the required attention exceeds the predetermined threshold value. Thus, in the above example, the communication could initially be paused, and if the particular driving situation lasts for longer than a predetermined time, the signal can be output.

According to a further aspect of the present disclosure, a device for controlling a communication of a driver of a motor vehicle with another person outside the motor vehicle comprises the following elements: a sensing apparatus for determining a driving situation of the motor vehicle; a processing apparatus for determining a level of attention of the driver required for driving the motor vehicle based on the driving situation; and for determining that the communication jeopardizes the required attention being achieved; and also an apparatus for influencing the communication as a function of the required attention.

The processing apparatus can be configured to carry out a method described herein, in full or in part. For this purpose, the processing apparatus can be electronic and in particular comprise a programmable microcomputer or microcontroller. The method can be in the form of a computer program product with program code. The computer program product can also be stored on a computer-readable data carrier. Features or advantages of the method can be transferred to the device or vice versa.

According to another aspect of the present disclosure, a motor vehicle comprises a device described herein. In particular, the motor vehicle can be a passenger car, a truck or a bus.

The present disclosure will now be described in more detail with reference to the accompanying drawings.

### BRIEF DESCRIPTION OF THE DRAWINGS

FIG. 1 shows a flowchart of a method;

FIG. 2 shows a system; and

FIG. 3 shows an illustration of a prediction of required attention.

### DETAILED DESCRIPTION OF THE DRAWINGS

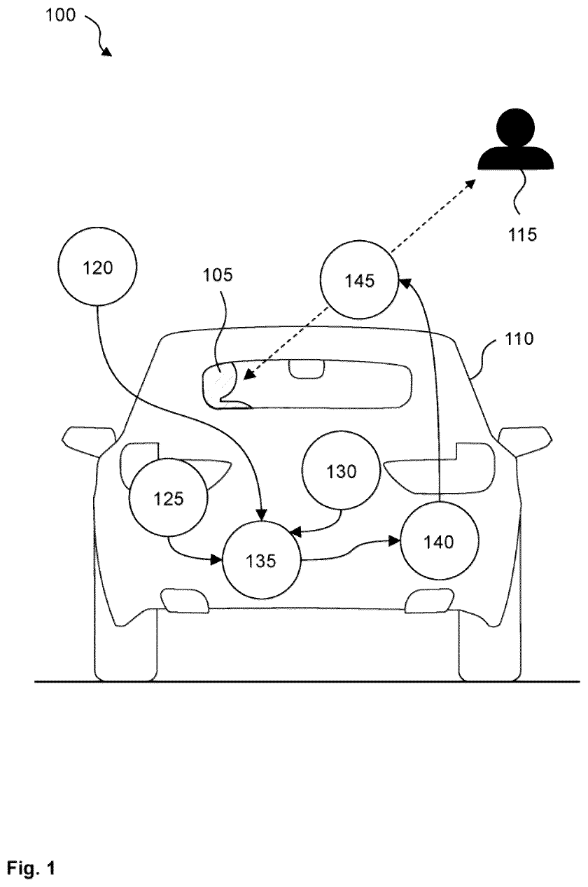

FIG. 1 shows a flowchart of a method 100 for controlling a communication of a driver 105 of a motor vehicle 110 with another person 115, who is outside the motor vehicle 110. The driver 105 either controls the motor vehicle 110 themselves or is responsible for monitoring the partially automatically or autonomously driving motor vehicle 110. The control relates in particular to the movement of the motor vehicle 110.

First, a driving situation of the motor vehicle 110 is supposed to be determined. To do this, an external driving situation can be determined in a step 120, a driving situation of the vehicle 110 can be determined in a step 125 and an internal driving situation can be determined in a step 130. Some factors based on which the driving situation can be determined can be assigned to different or even a plurality of steps.

The external driving situation can include aspects of where the motor vehicle 110 is located and what information needs to be considered to control the movement of the motor vehicle 110. In particular, the step 120 can relate to determining another road user, determining an obstacle, the course or condition of a road being driven on, a maneuver such as merging, turning or parking or an influence on the driving physics of the motor vehicle 110, for example a wet or icy road, a downhill gradient or crosswind.

Furthermore, it can be determined whether another road user is approaching or moving away, whether a vehicle is in an area with poor visibility (blind spot), whether another vehicle is changing lanes into the lane used by the motor vehicle 110, which signal is shown by a traffic light that the motor vehicle 110 is approaching, which change in the signal is probable or which noises can be determined in the environment. For example, the actuation of a horn, a siren, the horn of a train or a truck or the screeching of tires can indicate a particular driving situation.

Circumstances relating to navigation or route guidance of the motor vehicle 100 can also be determined. This can include, for example, a road layout, a maneuver to be performed or passage through an area in which increased attention is required, such as a residential area, a kindergarten, a hospital, a school, an event venue or a pedestrian zone. Furthermore, dynamic information that can influence navigation or route guidance can be taken into account, for example a warning of a traffic jam, an accident site, a pothole, an object on the road or deformation of the road due to heat.

The driving situation related to the motor vehicle 110 can include aspects of how the motor vehicle 110 can be controlled in its environment. This includes, in particular, technical aspects that specify limits of the control. In step 125, therefore, in particular a speed of travel, a direction or turn signal that has been given, an acceleration or deceleration, or a lighting situation can be determined. In addition, a driving maneuver performed or about to be performed with the motor vehicle 110, such as turning, overtaking, changing lanes, parking, stopping or driving off, can be determined. Furthermore, a traffic density can be determined on a road which the motor vehicle is traveling on, alternatively by on-board sensors or a messaging service such as RTTI. Other typical processes that lead to increased attention being required include requesting a parking or toll ticket or ordering or paying through the window, for example at a bank or snack bar.

The internal driving situation can include aspects that may affect the driver 105 and impair their ability to focus their attention. For example, in step 130, it can be determined whether the driver 105 is still engaged in an additional activity, such as eating or smoking. Furthermore, it can be determined whether they interact with the motor vehicle 110, for example whether they operate switches or other operating elements of the motor vehicle 110 or use gesture or voice control, for example.

It can be determined whether another person is on board the motor vehicle 110, for example a passenger or a child or infant, and it can be determined whether the other person is occupying the attention of the driver 110. It can be determined whether a support system for the driver 105 is present, whether it is active or to what extent it intervenes in the control of the motor vehicle 110. It can be determined whether the driver 105 is tired, how long a current journey has already lasted, how long it is expected to last or what mood the driver 105 is in. Whether the driver 105 is under time pressure can be determined based on entries in an electronic calendar.

Aspects of the communication with the external person 115 can also contribute to the internal driving situation. For example, it can be determined whether the driver 105 participates more passively or to what extent they also actively participate. It can be determined how many external people 115 participate in the communication. A transmission quality of the communication, for example with regard to noise or dropouts, can be determined. It can also be determined which external person 115 the driver 105 is communicating with, how long the conversation has already lasted or how long it is expected to last.

In a step 135, an imminent driving situation can be predicted based on the determinations made. A statistical model, a self-enhancing filter, such as a Kalman filter, or a machine learning approach can be used for this purpose. For example, an artificial neural network (ANN) can be trained to determine a particular driving situation in which an increased level of attention is required from the driver 105. The increased level of attention can be predicted. Preferably, it is predicted how the required level of attention will develop in a subsequent period of time. Several characteristics can be determined, each with associated confidences or probabilities. This determination can be carried out on an ongoing basis, wherein a characteristic that has become improbable can be discarded.

The determinations made can be contextualized with one another and/or saved. In one or more embodiments, the experiences of other drivers 105 in other motor vehicles 110 can be taken into account. Such experiences or certain driving situations or certain required levels of attention can be processed or distributed centrally. The prediction can be made based on externally sourced data.

In a step 140, a required attention of the driver 105 can be determined based on the driving situation or the prediction thereof. The required attention can also be predicted and various characteristics can also be predicted and provided with confidences or probabilities here. Preferably, it is determined whether the required attention exceeds a predetermined threshold value. In one or more embodiments, the threshold value can be determined dynamically, for example as a function of the determination of the internal driving situation in step 130.

In a step 145, the communication between the driver 105 and the external person 115 can be influenced. The transmission of the information can be influenced as part of the communication, for example by a speed of output of transmitted information to the driver 105 being reduced when the required attention is increased. In one or more embodiments, a signal can be provided to the driver 105 or the external person 115 to indicate the recommended reduction in the communication.

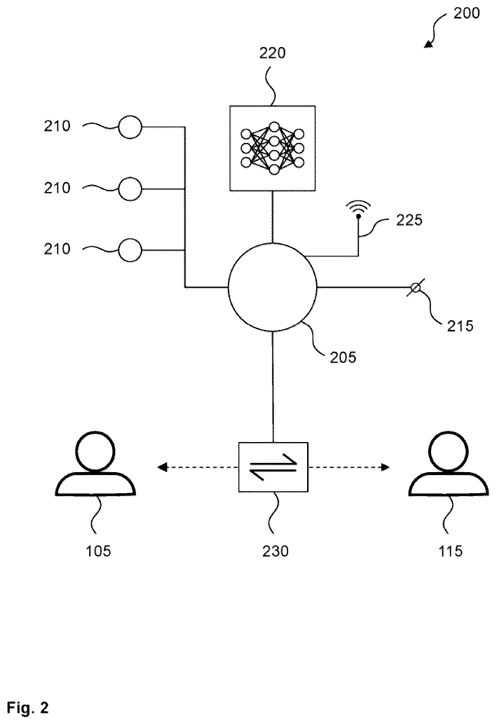

FIG. 2 shows a device 200 on board a motor vehicle 110. The device 200 comprises a processing apparatus 205, which can be connected to one or a plurality of sensors 210. Exemplary sensors include a camera, a radar sensor, a LiDAR sensor and an ultrasonic sensor. An interface 215 can be used to access a further source of information on board the motor vehicle 110, for example a navigation system, driving stability system or a system for controlling the speed of travel. The processing apparatus 205 can implement an ANN or be connected to an ANN 220. By a communication apparatus 225, observations, measured values, experiences or assignments made by another, similar device 200 can be received or corresponding information can be provided externally.

The processing apparatus 205 is also connected to an apparatus 230 via which the communication between the driver 205 and the person 215 can be influenced. In one or more embodiments, the apparatus 230 comprises an output apparatus to provide an audible or visual signal, an image or a video data stream. The provision can be made to the external person 115 and/or the driver 105. In one or more embodiments, the communication between the person 115 and the driver 105 is transmitted by the apparatus 225 such that it can be influenced. The influence can, for example, be filtering out or feeding in a signal, changing the speed of a transmitted data stream or increasing or decreasing an intensity of the flow of information.

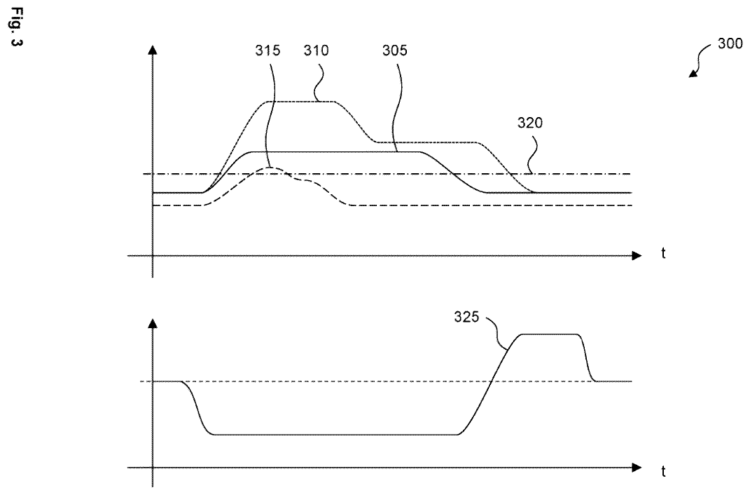

FIG. 3 shows an exemplary illustration 300 of a prediction of attention required from a driver 105 in order to drive a motor vehicle 110. A time is shown in the horizontal direction. In the vertical direction, a certain required attention of the driver is shown for an upper section of the representation and an intensity of the communication is shown in a lower section.

A first characteristic 305 represents a prediction of the required attention, wherein this prediction is assigned a high probability. The characteristic shown can be present, for example, when merging onto a highway when the motor vehicle 105 is accelerated onto an access road or into an acceleration lane and steered into an adjacent lane. There is often only a limited distance and therefore only a limited time available for this maneuver. Depending on the number of vehicles in the lane, the speed being driven there and the ability of the motor vehicle 110 to accelerate, merging can be difficult and require a high level of concentration from the driver 105.

A second characteristic 310 represents a prediction for the same process, wherein the second characteristic 310 has a lower probability. The second characteristic 310 could be produced, for example, if merging is made more difficult by a lane change of another road user to the intended lane. A third characteristic 315, which has the lowest of the determined probabilities, may relate to the same process under optimal conditions, for example when there are no other vehicles in the vicinity of the motor vehicle 110.

The characteristics 305-315 can be compared with a threshold value 320. If a characteristic 305-315 exceeds the threshold value 320, a particular driving situation with increased attention required from the driver 105 may be present and the communication between the driver and the external person 115 can be influenced.

A fourth characteristic 325 shows an exemplary influence on the communication as a function of the first characteristic 305. The communication is already reduced before the characteristic 305 has reached the threshold value 320. The communication is preferably reduced with a smooth transition. The communication can be raised again when the particular driving situation is over, wherein a smooth transition is also preferably controlled here.

In this example, the influence could take the form of slowed-down output of received communication information. After being lowered, the speed can be increased above the natural level as shown in order to allow the driver 115 to catch up on the communication.

### Reference Signs

100 Method
105 Driver
110 Motor vehicle
115 Person
120 Determining external driving situation
125 Determining driving situation of the vehicle
130 Determining internal driving situation
135 Predicting driving situation
140 Determining required attention
145 Influencing communication
200 Device
205 Processing apparatus
210 Sensor
215 Interface
220 Artificial neural network, ANN
225 Communication apparatus
230 Apparatus
300 Illustration
305 First characteristic
310 Second characteristic
315 Third characteristic
320 Threshold value
325 Fourth characteristic

1-15. (canceled)

16. A method for controlling a communication of a driver of a motor vehicle with a second person outside the motor vehicle, comprising:
determining a driving situation of the motor vehicle;
determining a level of attention of the driver for driving the motor vehicle based on the driving situation;
determining that the communication jeopardizes the level of attention being achieved; and
influencing the communication as a function of the level of attention.

17. The method according to claim 16, wherein a distraction of the driver is determined which is independent of the driving situation and the communication, and wherein it is determined that the communication in combination with the distraction jeopardizes the level of attention being achieved.

18. The method according to claim 16, wherein a signal is provided to the driver.

19. The method according to claim 16, wherein a message transported as part of the communication is delayed.

20. The method according to claim 16, wherein a message transported as part of the communication is output to the driver with reduced urgency.

21. The method according to claim 16, wherein a signal is provided to the second person.

22. The method according to claim 21, wherein the signal is configured to convey to the second person an increased level of attention from the driver to drive the motor vehicle.

23. The method according to claim 21, wherein the signal is provided audibly.

24. The method according to claim 21, wherein the communication comprises transmitting an image to the second person, and the signal relates to a change in the image.

25. The method according to claim 16, wherein a type of influence is determined as a function of the communication.

26. The method according to claim 16, wherein an imminent driving situation is predicted and the level of attention for the imminent driving situation is determined.

27. The method according to claim 26, wherein it is predicted for how long the level of attention is above a predetermined threshold value; and wherein the communication is influenced as a function of a determined duration.

28. The method according to claim 16, wherein the communication is influenced as a function of a duration for which the level of attention exceeds a predetermined threshold value.

29. A device for controlling a communication of a driver of a motor vehicle with a second person outside the motor vehicle, wherein the device comprises:
a sensing apparatus for determining a driving situation of the motor vehicle;
a processing apparatus for determining a level of attention of the driver for driving the motor vehicle based on the driving situation; and for determining that the communication jeopardizes the level of attention being achieved; and
an apparatus for influencing the communication as a function of the level of attention.

30. A motor vehicle comprising a device for controlling a communication of a driver of the motor vehicle with a second person outside the motor vehicle, wherein the device comprises:
a sensing apparatus for determining a driving situation of the motor vehicle;
a processing apparatus for determining a level of attention of the driver for driving the motor vehicle based on the driving situation; and for determining that the communication jeopardizes the level of attention being achieved; and
an apparatus for influencing the communication as a function of the level of attention.
